(19) United States
(12) Patent Application Publication
(10) Pub. No.: US 2009/0273489 A1
(43) Pub. Date: Nov. 5, 2009

(54) System and method for transportation vehicle tracking

(75) Inventor: Jeffery Khuong Lu, Marietta, GA (US)

Correspondence Address: Jeffery Khuong Lu, 2611 Jesters Court, Marietta, GA, 30068, US

(73) Assignee: Jeffery Khuong Lu, Marietta, GA (US)

(21) Appl. No.: 12/151,076

(22) Filed: May 2, 2008

(51) Int. Cl. G08G 1/123

(52) U.S. Cl. 340/989

(57) ABSTRACT

A system and method for transportation vehicle tracking. A method for tracking a vehicle includes receiving information for the vehicle as the vehicle departs a starting location, creating a data record for the vehicle, receiving updated information for the vehicle, updating the data record for the vehicle, and finalizing the data record for the vehicle as the vehicle reaches a final location. The data record is located at a centralized data center and the update information is provided from an intermediate location.

### TECHNICAL FIELD

The present invention relates generally to a system and method for communications systems, and more particularly to a system and method for transportation vehicle tracking.

### BACKGROUND

The use of busses to transport passengers to and from a centralized location may be a cost effective way to move a large number of riders. Since a single bus may replace a potentially large number of cars, savings may be realized in reduced fuel consumption, traffic congestion, traffic accidents, and so forth. School busses may be particularly effective at transporting passengers since all of the passengers have a common destination and/or origination.

However, waiting for a school bus to arrive may be arduous, if not dangerous. Often a student may have to wait in the rain or cold, along side a busy road, in the dark, and so forth, for his/her school bus to arrive. The wait may be additionally taxing if the school bus is delayed due to weather, traffic, accident, vehicle breakdown, and so on.

FIG. 1a illustrates an exemplary bus route for a school bus. The diagram shown in FIG. 1a illustrates a path taken by a school bus as it leaves a bus depot 100 and makes a number of stops to pick up students. The school bus typically leaves the bus depot 100 at a time 8:10 AM and usually arrives at a first bus stop “STOP 1” 105 at time 8:15 AM. As it traverses its route, the school bus normally arrives at a second bus stop “STOP 2” 110 at time 8:18 AM, a third bus stop “STOP 3” 115 at time 8:21 AM, a fourth bus stop “STOP 4” 120 at time 8:24 AM, a fifth bus slop “STOP 5” 125 at time 8:27 AM, and a sixth bus stop “STOP 6” 125 at time 8:30 AM.

However, in between the third bus stop 115 and the fourth bus stop 120, the school bus encounters an accident 135. The accident 135 backs up traffic and the school bus cannot complete its normal route. Therefore, the school bus may not be able to reach the fourth bus stop 120, the fifth bus stop 125, and the sixth bus stop 125 at the usual times. Due to the accident 135, the school bus may need to turn around and take an alternate route. FIG. 1b illustrates an alternate bus route for the school bus. Taking the alternate route delays the school bus and the school bus does not arrive at the fourth bus stop 120 until 8:40 AM, the fifth bus stop 125 until 8:43 AM, and the sixth bus stop 130 until 8:46 AM. The students waiting at the fourth bus stop 120, the fifth bus stop 125, and the sixth bus stop 130 have had to wait longer than necessary for the school bus to arrive.

### SUMMARY OF THE INVENTION

These and other problems are generally solved or circumvented, and technical advantages are generally achieved, by embodiments of a system and a method for transportation vehicle tracking.

In accordance with an embodiment, a method for method for tracking a vehicle is provided. The method includes receiving information for the vehicle as the vehicle departs a starting location, creating a data record for the vehicle, wherein the data record is located at a centralized data center, receiving updated information for the vehicle, wherein the update information is provided from an intermediate location, updating the data record for the vehicle, and finalizing the data record for the vehicle as the vehicle reaches a final location.

In accordance with another embodiment, a method for exchanging information is provided. The method includes receiving a first transmission from a first communications unit, associating a departure time with the first transmission, updating the departure time in response to a determining that a second transmission was received from the first communications unit, and transmitting the departure time to a database in response to a determining that a difference between the departure time and a current time is greater than a transmission interval.

In accordance with another embodiment, a vehicle tracking system is provided. The vehicle tracking system includes a vehicle communications unit located in a vehicle, a location communication unit wireless coupled to the vehicle communications unit, with one location communications unit located at each of a number of specified locations throughout the vehicle tracking system, and a central server coupled to the location communications unit. The vehicle communications unit transmits an identifier associated with the vehicle, the location communications unit maintains a departure time and a location for the vehicle, and the central server maintains time and location information about the vehicle and provides the time and location information to subscribers.

An advantage of an embodiment is that little additional hardware may be needed. Therefore, the deployment of an embodiment may be had for a small investment.

A further advantage of an embodiment is that a relatively accurate prediction of a vehicle's arrival time may be achieved, thereby reducing a wait time for passengers.

The foregoing has outlined rather broadly the features and technical advantages of the present invention in order that the detailed description of the embodiments that follow may be better understood. Additional features and advantages of the embodiments will be described hereinafter which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the embodiments, and the advantages thereof, reference is now made to the following descriptions taken in conjunction with the accompanying drawings, in which:

FIG. 1a is a diagram of a bus route for a school bus;

FIG. 1b is a diagram of a bus route for a school bus, wherein the school bus takes an alternate route due to an accident;

FIG. 2 is a diagram of a bus tracking and arrival time information system;

FIGS. 3a and 3b are diagrams of bus communications units;

FIGS. 4a and 4b are diagrams of bus stop communications units;

FIGS. 5a and 5b are diagrams of sequences of events in the operation of a bus communications unit;

FIG. 6 is a diagram of a sequence of events in the operation of a central server;

FIG. 7 is a diagram of a sequence of events in the operation of a bus stop communications unit; and

FIG. 8 is a diagram of a vehicle tracking system.

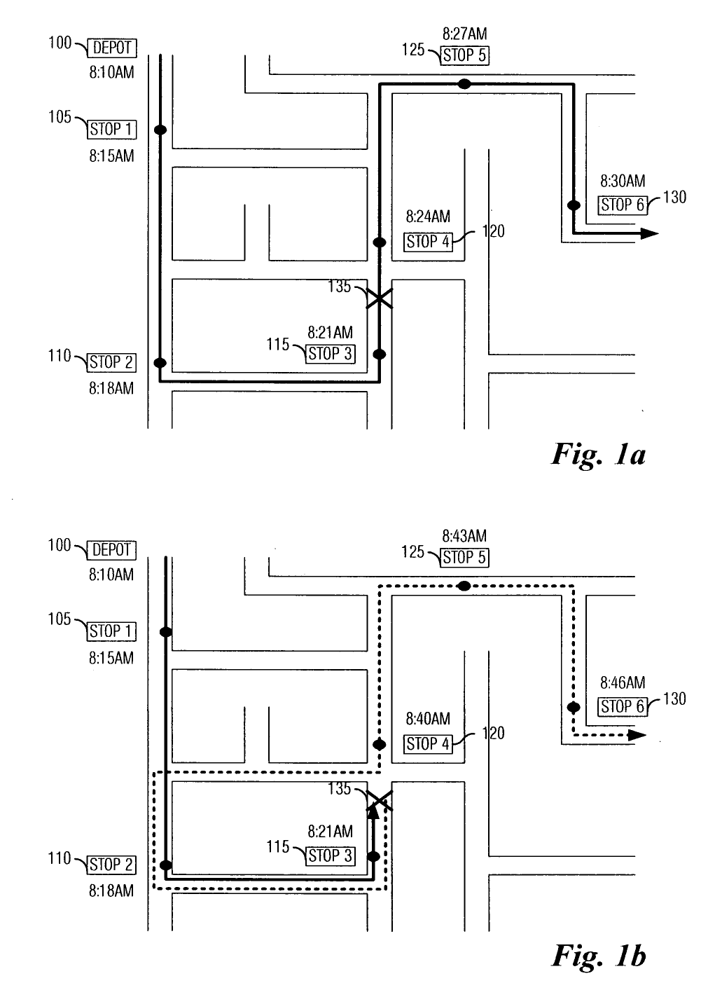

### DETAILED DESCRIPTION OF ILLUSTRATIVE EMBODIMENTS

The making and using of the embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The embodiments will be described in a specific context, namely a bus tracking and arrival time information system. The invention may also be applied, however, to other forms of mass transit, including mass transit busses. Furthermore, the invention may be applied to public vehicle or fleet vehicle tracking, traffic flow analysis, arrival time information, and so forth.

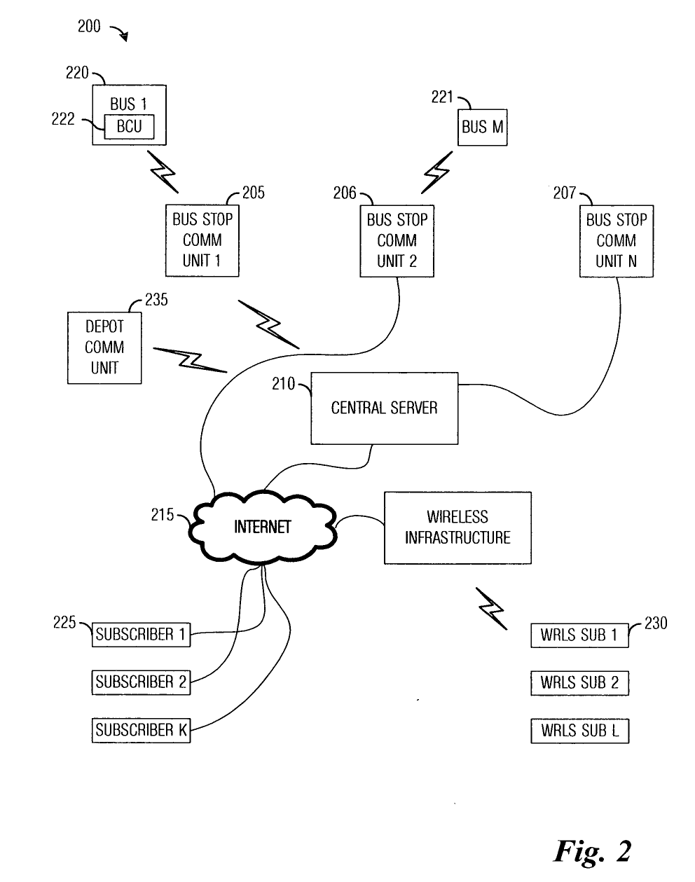

With reference now to FIG. 2, there is shown a diagram illustrating a bus tracking and arrival time information system (BTATIS) 200. The BTATIS 200 includes a number of bus stop communications units, such as a first bus stop communications unit 205, a second bus stop communications unit 206, and an N-th bus stop communications unit 207. A bus stop communications unit may communicate to a central server 210 via a wireless connection or a wired connection.

The type of connection between a bus stop communications unit and the central server 210 may be dependent on a proximity of a bus stop communications unit to the central server 210 and available communications infrastructure. For example, if a bus stop communications unit, such as the N-th bus stop communications unit 207, is in close proximity to a public switched telephone network (PSTN), for example, then a wired connection may provide a reliable connection without significant expense. Additionally, a bus stop communications unit may communicate with the central server 210 using other forms of networks, such as a data network that is used to connect traffic lights to a central controller. The bus stop communications unit may use these networks as another method for exchanging information. However, if a bus stop communications unit, such as the first bus stop communications unit 205, is not in close proximity to the PSTN or some other wired infrastructure, then a wireless connection utilizing a cellular network, a metropolitan area network, such as WiMAX, Bluetooth, and so forth, may be necessary. Alternatively, a bus stop communications unit may be indirectly connected to the central server 210. For example, a bus stop communications unit, such as the second bus stop communications unit 206, may be indirectly connected to the central server 210 via an Internet 215 connection, or some other form of data network.

When a bus, such as a first bus 220 or an M-th bus 221, arrives at a bus stop, the bus stop's bus stop communications unit may communicate with the bus and obtain an identifier for the bus. A bus, such as the first bus 220, may contain a bus communications unit (BCU), such as a BCU 222. The BCU 222 may be used to communicate the identifier of the first bus 220 to a bus stop communications unit, such as the first bus stop communications unit 205, by periodically transmitting identifier to the first bus stop communications unit 205. Alternatively, the BCU 222 may transmit its identifier only when it receives a request from the first bus stop communications unit 205 to provide its identifier. The communications between a BCU and a bus stop communications unit may be restricted in terms of distance. For example, a BCU and a bus stop communications unit may communicate only when they are in relatively close proximity.

As the bus leaves the bus stop, the bus stop's bus stop communications unit may provide the bus identifier and its departure time to the central server 210. The central server 210 may use the information communicated by the bus stop communications unit to update information associated with the bus identifier. Examples of information associated with the bus identifier may include route information, current location, estimated time for arrival at a next bus stop, as well as historical timing information. The central server 210 may utilize the historical timing information in its computing of the estimated time for arrival at a next bus stop.

After updating the information, the central server 210 may provide the information to subscribers, such as a first subscriber 225, over a wired connection or a first wireless subscriber 230, over a wireless connection. For example, a subscriber may be a student or a parent of a student waiting for the arrival of a school bus. A subscriber may also be schools that are served by the school buses or information providers, such as radio or television stations, desirous to provide school bus information to listeners or viewers.

The BTATIS 200 also includes a depot communications unit 235. The depot communications unit 235 may be located at a bus depot, a school, a central station, or so forth, and may be used to initiate the tracking of a bus as it leaves the bus depot, school, central station, or so on. For example, as a bus, such as the first bus 220, leaves the bus depot to begin its route, the depot communications unit 235 may communicate with a BCU, such as the BCU 222, to obtain the identifier of the first bus 220. The depot communications unit 235 may then communicate with the central server 210 either via a wired or wireless network to initiate the tracking of the first bus 220. Additionally, once the first bus 220 returns to the bus depot, the depot communications unit 235 may communicate with the BCU 222 of the first bus 220 and then the central server 210 to end the tracking of the first bus 220. The depot communications unit 235 may be a dedicated bus stop communications unit located at a bus depot, a school, a central station, or so on.

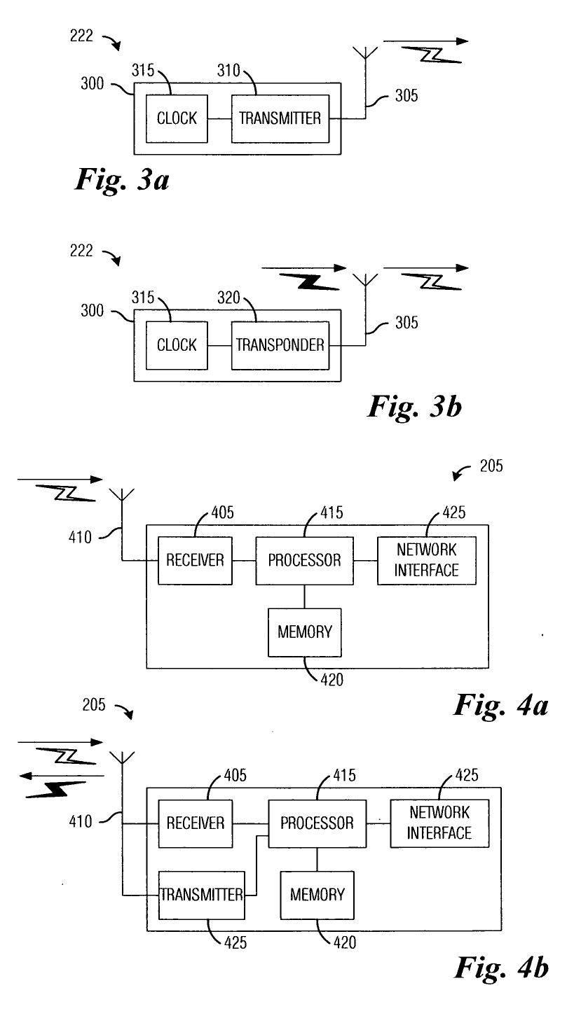

FIG. 3a illustrates a detailed view of a BCU, such as the BCU 222 of the first bus 220. The BCU 222 includes a communications unit 300 that may be coupled to an antenna 305. The communications unit 300 includes a transmitter 310 that may be used to transmit the identifier of the first bus 220. The identifier of the first bus 220 may be stored in a memory location that may be a part of the communications unit 300. Since the identifier of the first bus 220 will likely not change, the identifier of the first bus 220 may be stored in non-volatile or permanent memory. The communications unit 300 also includes a clock 315 that may be used to time transmissions of the identifier of the first bus 220 by the BCU 222. For example, the BCU 222 may be configured to transmit the identifier of the first bus 220 once every 10 seconds, 15 seconds, 20 seconds, or so forth, the clock 315 may provide a timing signal that has a period of 10 (15 or 20) seconds or some fraction of 10 (15 or 20) seconds. The clock 315 may also be used to provide a time stamp for transmissions made by the BCU 222.

The frequency of the transmissions made by the BCU 222 may be depend on factors such as expected speed of the busses, number of busses, network bandwidth, power consumption, and so forth. The illustrative use of 10, 15, or 20 seconds for a period of transmissions made by the BCU 222 is for discussion purposes only and should not be construed as being limiting to either the scope or the spirit of the embodiments.

FIG. 3b illustrates a detailed view of a BCU, such as the BCU 222. The BCU 222 includes the communications unit 300 that may be coupled to an antenna 305. The communications unit 300 includes a transponder 320 that may be used to transmit the identifier of the first bus 220 in response to a request from a bus stop communications unit, such as the first bus stop communications unit 205. As the BCU 222 (contained in the first bus 220) comes into close proximity to a bus stop communications unit, such as the first bus stop communications unit 205, it may receive the request (for example, a predefined signal) transmitted by the first bus stop communications unit 205. In response to the predefined signal from the first bus stop communications unit 205, the BCU 222 may transmit the identifier of the first bus 220. The transponder 320 may be a RFID device, a near field communications (NFC) transponder, a near field magnetic communications transponder, and so forth.

The communications unit 300 may also include the clock 315, which may be used to time stamp responses made by the transponder 320. Alternatively, once the communications unit 300 receives the request, the communications unit 300 may be configured to periodically transmit the identifier of the first bus 220 for a specified amount of time, such as several minutes. The clock 315 may then be used to provide a timing signal for the periodic transmission of the identifier of the first bus 220.

FIG. 4a illustrates a detailed view of a bus stop communications unit, such as the first bus stop communications unit 205. It may be necessary only for the first bus stop communications unit 205 to perform one-way communications with a BCU, such as the BCU 222. For example, the BCU 222 may be configured to periodically transmit the identifier of a bus, such as the first bus 220. In this situation, the first bus stop communications unit 205 may not need the capability of transmitting to the BCU 222. The first bus stop communications unit 205 includes a receiver 405 for receiving over-the-air transmissions made by the BCU 222 by way of an antenna 410. The first bus stop communications unit 205 also includes a processor 415 for performing operations such as computing arrival and departure times for busses as well as performing communications with the central server 210. Furthermore, the processor 415 may be able to retrieve information about the first bus 220 from the central server 210. A memory 420 may be used to store information including the arrival and departure times of busses, and so forth.

A network interface 425 may be used by the first bus stop communications unit 205 to communicate with the central server 210. As discussed previously, the first bus stop communications unit 205 may communicate with the central server 210 via a wireless or wired network and the network interface 425 may be capable of supporting wired, wireless, or both communications methods.

FIG. 4b illustrates a detailed view of a bus stop communications unit, such as the first bus stop communications unit 205. FIG. 4b illustrates the first bus stop communications unit 205 that may be capable of transmitting to a BCU, such as the BCU 222. The first bus stop communications unit 205 may periodically transmit a specified sequence requesting that any BCU, such as the BCU 222, transmit the identifier of its associated bus. The BCU 222, upon receipt of the specified sequence may transmit the identifier of its associated bus.

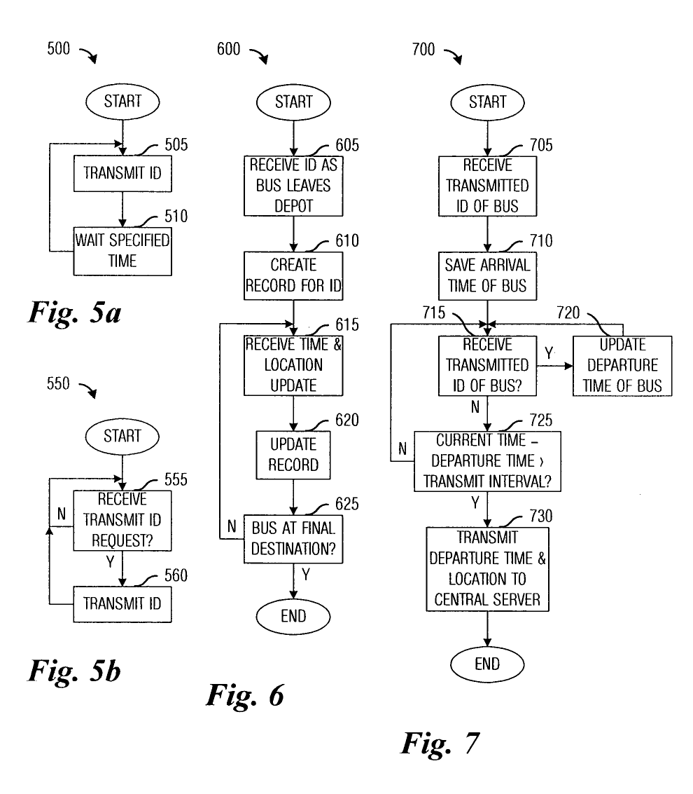

FIG. 5a illustrates a sequence of events 500 in the operation of a BCU, such as the BCU 222. The BCU 222 may be configured to periodically transmit the identifier of its associated bus, such as the first bus 220. The duration of the identifier transmissions may be specified. The operation of the BCU 222 may begin with the BCU 222 transmitting the identifier of the first bus 220 (block 505). Then, the BCU 222 may wait for a period of time substantial equal to a transmission period specified by a BTATIS, such as the BTATIS 200, for example (block 510). The BCU 222 may make use of a clock, such as the clock 315, to help ensure that it transmits the identifier of the first bus 220 at specified intervals. Although shown in FIG. 5a with the BCU 222 transmitting the identifier of the first bus 220 prior to waiting the period of time, it may be possible for the BCU 222 to first wait the period of time and then transmitting the identifier of the first bus 220. After waiting the period of time, the BCU 222 may repeat the transmitting of the identifier of the first bus 220 (block 505) and the waiting (block 510).

FIG. 5b illustrates a sequence of events 550 in the operation of a BCU, such as the BCU 222. Instead of periodically transmitting the identifier of its associated bus, such as the first bus 220, the BCU 222 may also transmit the identifier of the first bus 220 only after it receives a specified sequence from a bus stop communications unit, such as the first bus stop communications unit 205, for example. When the BCU 222 receives the specified sequence (block 555), it may then transmit the identifier of the first bus 220 (block 560). If the BCU 222 does not receive the specified sequence, it may continue to wait until it receives the specified sequence or until there is no longer a need for the BCU 222 to continue waiting for the specified sequence, such as when the first bus 220 returns to the bus depot at the end of the day, for example.

FIG. 6 illustrates a sequence of events 600 in the operation of a central server, such as the central server 210. The central server 210 may operate as a centrally located database and data processing unit for the BTATIS 200 and may be in continuous operation while there are busses in operation. The operation of the central server 210 may begin when the central server 210 initially receives an identifier of a bus, such as the first bus 220, as the first bus 220 leaves the bus depot (block 605). With an initial reception of the identifier of the first bus 220, the central server 210 may create a data record that may be associated with the first bus 220 (block 610). The data record may contain information such as a departure time for the first bus 220, information pertaining to a route for the first bus 220, the first busses' driver, and so forth. The data record may be stored in a database contained in the central server 210.

As the first bus 220 makes stops at bus stops along its route, a BCU, such as the BCU 222, may transmit the identifier of the first bus 220 to a bus stop communications unit, such as the first bus stop communications unit 205. When first bus stop communications unit 205 receives the identifier of the first bus 220, the first bus stop communications unit 205 may relay a time when it receives the identifier of the first bus 220 to the central server 210. The first bus stop communications unit 205 may also transmit the identifier of the first bus 220 along with the time in a transmission to the central server 210.

When the central server 210 receives the time transmitted by the first bus stop communications unit 205 along with the identifier of the first bus 220 (block 615), the central server 210 may update the data record (block 620). The central server 210 may replace information contained in the data record, such as the location of the first bus 220 and the current time.

Furthermore, the central server 210 may compute information related to the first bus 220 using the information that it has regarding the first bus 220. For example, the central server 210 may be able to compute an expected arrival time of the first bus 220 at any remaining bus stops on its route, an expected arrival time at a school, an expected arrival time at a bus depot, and so forth. Furthermore, using historical data pertaining to the first bus 220, the central server 210 may be able to determine traffic conditions along the route of the first bus 220. It may be able to utilize this information to reroute the first bus 220 as well as other busses operating in the vicinity.

The central server 210 may also check to determine if the first bus 220 is at its final destination (block 625). If the first bus 220 is at its final destination, then the central server 210 may cease updating the data record associated with the first bus 220 or it may delete, mark as complete, archive, and so on, the data record altogether.

Each time the central server 210 updates a data record, such as the data record associated with the first bus 220, the information contained in the database or any information that has been changed since a last update, may be provided to subscribers. The information provided to subscribers may be filtered depending on the type of subscribers and potentially, their subscription plan.

FIG. 7 illustrates a sequence of events 700 in the operation of a bus stop communications unit, such as the first bus stop communications unit 205. The first bus stop communications unit 205 may maintain a temporary database that it may store in a memory, such as the memory 420. The temporary database may contain information regarding busses that are within transmission range of the first bus stop communications unit 205, for example. The information may be created as a bus comes within the range of the first bus stop communications unit 205 and deleted as the bus exits the range of the first bus stop communications unit 205. Prior to deletion, the records associate with the bus may be added or updated to the central server 210.

The operation of the first bus stop communications unit 205 may begin when the first bus stop communications unit 205 receives an identifier associated with a bus, such as the first bus 220 (block 705). The identifier may be received after the first bus stop communications unit 205 transmitted a specified sequence requesting BCUs, such as the BCU 222, within listening range to transmit identifiers. When the first bus stop communications unit 205 receives the identifier of the first bus 220, the first bus stop communications unit 205 may create a temporary data record for the first bus 220 (block 710). The temporary data record may contain information such as the identifier of the first bus 220, arrival time of the first bus 220, departure time of the first bus 220, and so forth.

The first bus stop communications unit 205 may continue to periodically transmit the specified sequence requesting BCUs within listening range to transmit identifiers, and when the first bus stop communications unit 205 receives another transmission from the BCU 222 with the identifier of the first bus 220 (block 715), the first bus stop communications unit 205 may update the departure time of the first bus 220 (block 720). The first bus stop communications unit 205 may then check to determine if the first bus 220 has departed the bus stop (block 725). The first bus stop communications unit 205 may perform the check by computing an interval that may be defined as a current time (maintained at the first bus stop communications unit 205, for example) minus the departure time of the first bus 220 and comparing it with an identifier transmit interval (block 725). The identifier transmit interval may be a duration between transmissions of the specified sequence requesting BCUs within listening range to transmit identifiers or a duration between transmissions of identifiers by BCUs.

If the computed interval is greater than the identifier transmit interval (block 725), then the first bus 220 may be determined as having departed from the bus stop, and the departure lime of the first bus 220 may be transmitted to the central server 210 (block 730). In addition to the departure time of the first bus 220, the first bus stop communications unit 205 may also transmit information about the location of the first bus stop communications unit 205 to the central server 210.

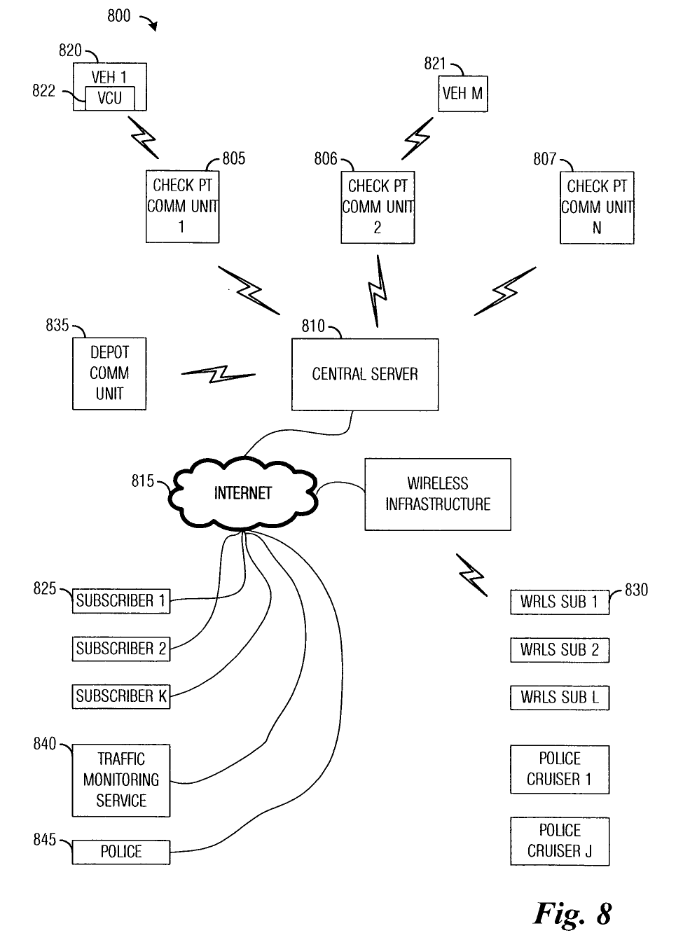

FIG. 8 illustrates a vehicle tracking system (VTS) 800. The VTS 800 may be used to track the location of vehicles, such as government vehicles, mass transit vehicles (busses, vans, cars, subway trains, trains, and so forth), delivery trucks, passenger cars, rental vehicles, and so forth. In addition to tracking vehicle position, the VTS 800 may be used to target information to specific vehicles based on their location, travelled path, operating speed, traffic control, and so forth. Additionally, the VTS 800 may be used by parents to maintain a track on their children. Furthermore, information provided by the VTS 800 may be used in legal proceedings or criminal activity analysis. The targeted information may include driving directions, road conditions, advertisements, entertainment, and so forth. The targeted information may be provided directly to displays, audio players, and other devices in the vehicle or to information displays installed in the general environment, such as road signs, billboards, and so forth.

The VTS 800 includes a number of check point communications units, such as a first check point communications unit 805, a second check point communications unit 806, and an N-th check point communications unit 807. A check point communications unit may be installed at a variety of locations within an operating area of the VTS 800. For example, a check point may include traffic lights as well as traffic control signs, traffic camera locations, specified buildings, places of business, and so forth. A check point communications unit may communicate to a central server 810 via a wireless connection or a wired connection.

The type of connection between a check point communications unit and the central server 810 may be dependent on a proximity of a bus stop communications unit to the central server 810 and available communications infrastructure. For example, if a check point communications unit, such as the N-th check point communications unit 807, is in close proximity to a public switched telephone network (PSTN), for example, then a wired connection may provide a reliable connection without significant expense. However, if a check point communications unit, such as the first check point communications unit 805, is not in close proximity to the PSTN or some other wired infrastructure, then a wireless connection utilizing a cellular network, a metropolitan area network, such as WiMAX, and so forth, may be necessary. Alternatively, a check point communications unit may be indirectly connected to the central server 810. For example, a check point communications unit, such as the second check point communications unit 806, may be indirectly connected to the central server 810 via an Internet 815 connection, or some other form of data network.

When a vehicle, such as a first vehicle 820 or an M-th bus 821, arrives at a check point, the check point's check point communications unit may communicate with the vehicle and obtain an identifier for the vehicle. A vehicle, such as the first vehicle 820, may contain a vehicle communications unit (VCU), such as a VCU 822. The VCU 822 may be used to communicate the identifier of the first vehicle 820 to a check point communications unit, such as the first check point communications unit 805, by periodically transmitting identifier to the first check point communications unit 805. Alternatively, the VCU 822 may transmit its identifier only when it receives a request from the first check point communications unit 805 to provide its identifier.

As the vehicle leaves the check point, the check point's check point communications unit may provide the vehicle identifier and its departure time to the central server 810. The central server 810 may use the information communicated by the check point communications unit to update information associated with the vehicle identifier. Examples of information associated with the check point identifier may include route information, current location, driving performance information, as well as historical timing information. The central server 810 may utilize the historical timing information in its computing of the estimated time for arrival at a next stop for the first vehicle 820. The information maintained by the central server 810 may also be used to target driving condition information to the first vehicle 820. If there is a need to direct the first vehicle 820 to a specific location, the information maintained by the central server 810 may be used to provide driving instructions to the first vehicle 820.

After updating the information, the central server 810 may provide the information to subscribers, such as a first subscriber 825, over a wired connection or a first wireless subscriber 830, over a wireless connection. For example, a subscriber may be the owner of a delivery vehicle desiring to keep control of the delivery vehicle as well has having an ability to redirect the delivery vehicle as needed. A subscriber may also be places of business that routinely gets deliveries and wishes to have an accurate estimate of delivery times and delivery vehicle status.

The VTS 800 also includes a depot communications unit 835. The depot communications unit 835 may be located at a bus depot, a school, a central station, or so forth, and may be used to initiate the tracking of a vehicle as it leaves the bus depot, school, central station, or so on. For example, as a vehicle, such as the first vehicle 820, leaves a dispatch station to begin its daily delivery out, the depot communications unit 835 may communicate with a VCU, such as the VCU 822, to obtain the identifier of the first vehicle 820. The depot communications unit 835 may then communicate with the central server 810 either via a wired or wireless network to initiate the tracking of the first vehicle 820. Additionally, once the first vehicle 820 returns to the dispatch station, the depot communications unit 835 may communicate with the VCU 822 of the first vehicle 820 and then the central server 810 to end the tracking of the first vehicle 820. The depot communications unit 835 may be a dedicated check point communications unit located at a bus depot, a school, a central station, or so on.

In addition to providing a vehicle's information to a commercial subscriber, the VTS 800 may provide traffic information to government subscribers, such as traffic monitoring department 840, police department 845, fire department, emergency services, and so forth. The traffic information provided by the VTS 800 may be used by the traffic monitoring department 840 to monitor and control traffic in the operating area of the VTS 800. For example, if the traffic monitoring department notices that a portion of the operating area of the VTS 800 is becoming congested, then driving instructions may be provided to vehicles in the area to help clear the congestion. The police department 845 may make use of the traffic information to track and locate vehicles used in crimes and so forth. Additionally, the police department 845 may also be able to make use of the traffic information to help keep civilians out of an area where there may be police activity.

Although the embodiments and their advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for tracking a vehicle, the method comprising:
receiving information for the vehicle as the vehicle departs a starting location;
creating a data record for the vehicle, wherein the data record is located at a centralized data center;
receiving updated information for the vehicle, wherein the update information is provided from an intermediate location;
updating the data record for the vehicle; and
finalizing the data record for the vehicle as the vehicle reaches a final location.

2. The method of claim 1, wherein the receiving update information comprises receiving a departure time of the vehicle at the intermediate location and an identifier of the intermediate location.

3. The method of claim 1, wherein the updating the data record comprises updating a departure time of the vehicle from the intermediate location and a current location of the vehicle.

4. The method of claim 3, further comprising after the updating the data record, providing the data record to subscribers.

5. The method of claim 4, wherein the providing the data record comprises:
placing the data record on a remotely accessible database; and
informing subscribers of the updated data record.

6. The method of claim 4, wherein the providing the data record comprises updating information on an Internet webpage.

7. The method of claim 1, wherein the finalizing comprises storing the data record in a data storage device.

8. The method of claim 1, wherein the vehicle follows a known route, and the updating comprises:
computing an estimated arrival time for the vehicle to a subsequent location after the vehicle's current location; and
providing the estimated arrival time to the subsequent location to subscribers.

9. The method of claim 1, further comprising after the updating:
computing a traffic congestion map; and
providing the traffic congestion map to subscribers.

10. A method for exchanging information, the method comprising:
receiving a first transmission from a first communications unit;
associating a departure time with the first transmission;
updating the departure time in response to a determining that a second transmission was received from the first communications unit; and
transmitting the departure time to a database in response to a determining that a difference between the departure time and a current time is greater than a transmission interval.

11. The method of claim 10, further comprising prior to the receiving the first transmission, transmitting a transmission request.

12. The method of claim 11, wherein the transmitting the transmission requests occurs with an interval substantially equal to the transmission interval.

13. The method of claim 10, wherein the transmitting further comprises transmitting a location to the database.

14. The method of claim 10, wherein the first communications unit periodically transmits, wherein a period of the transmission is substantially equal to the transmission interval.

15. The method of claim 10, wherein the first transmission is an identifier of the first communications unit.

16. The method of claim 10, further comprising after the updating, repeating the updating until the difference between the departure time and the current time is greater than the transmission interval

17. A vehicle tracking system comprising:
a vehicle communications unit located in a vehicle, the vehicle communications unit configured to transmit an identifier associated with the vehicle;
a location communication unit wireless coupled to the vehicle communications unit, with one location communications unit located at each of a number of specified locations-f throughout the vehicle tracking system, the location communications unit configured to maintain a departure time and a location for the vehicle; and
a central server coupled to the location communications unit, the central server configured to maintain time and location information about the vehicle and to provide the time and location information to subscribers.

18. The vehicle tracking system of claim 17, wherein the vehicle communications unit is further configured to periodically transmit the identifier, and wherein the location communications unit is configured to update the departure time for the vehicle with a time of a received transmission from the vehicle communications unit.

19. The vehicle tracking system of claim 17, wherein the location communications unit is further configured to provide the departure time and the location for the vehicle to the central server if a difference between the departure time for the vehicle and a current time is greater than a periodic transmit interval of transmissions made by the vehicle communications unit.

20. The vehicle tracking system of claim 17, further comprising a public accessible database coupled to the central server, the public accessible database configured to allow subscribers access to information about the vehicle.

21. The vehicle tracking system of claim 17, wherein the location communications unit comprises a processor configured to compute an estimated arrival time for the vehicle at a location in the vehicle tracking system.
